(19) United States
(12) Patent Application Publication
(10) Pub. No.: US 2021/0146231 A1
(43) Pub. Date: May 20, 2021

(54) GAME SYSTEM, GAME SHEET, GAME PROGRAM, AND GAME DEVICE

(71) Applicant: Yuri HOSOKUNI, Fukuoka (JP)

(72) Inventors: Yuri HOSOKUNI, Fukuoka (JP); Duncan Edward HUGHES, Fukuoka (JP)

(21) Appl. No.: 16/873,340

(22) PCT Filed: Mar. 21, 2018
(86) PCT No.: PCT/JP2018/011239

§ 371 Date: Sep. 30, 2020

(30) Foreign Application Priority Data
Sep. 27, 2017 (JP) 2017-185724

(51) Int. Cl. A63F 3/00

(52) U.S. Cl. CPC A63F 3/00643; A63F 3/00574; A63F 2003/00716; A63F 2003/00583; A63F 3/00697

(57) ABSTRACT

There is provided a game system that can be easily enjoyed by people of a wide range of ages, hardly makes players bored even after consecutive matches, and can be played by various number of players. The game system is designed to be played by at least two players, and includes a game board provided with a plurality of scattered dots and a plurality of marks arranged at positions spaced from the plurality of dots; positioners to be arranged at any of the plurality of dots and assigned to each of the players; and boundary indicators made of flexible string material and used to linearly connect the positioners arranged at any of the plurality of dots among the plurality of positioners assigned to each player.

### TECHNICAL FIELD

The present disclosure relates to a game system, a game sheet, a game program, and a game device for playing a game played by two or more players.

### BACKGROUND

Conventionally, various board games such as Go, Shogi, chess, and Othello (registered trademark) have been known. Board games are not only toys for spending leisure time, but are also used as communication tools to deepen fellowship. Moreover, board games are expected to have effects of developing learning/intellectual abilities, preventing dementia, and alleviating symptoms of dementia.

In addition to the traditional board games described above, new board games have been proposed in recent years. For example, Patent Literature 1 discloses a game using pieces formed in a triangular pyramid of which each face is colored differently and each vertex corner facing the respective face is colored with the same color; and a game board provided with holes/depressions or protrusions so that the pieces do not fall over when the pieces are placed with the vertex corners facing down. In this game, each player choses one of the colors on the pieces as the player's own color, and places a piece on the game board with the face of the player's own color facing up. When a newly-placed piece and a previously-placed piece of one player flank any piece of other players, the one player gets the flanked piece (by facing the face of the one player's own color up) to expand the one player's territory. Two to four players can participate in this game.

### CITATION LIST

### Patent Literature

Patent Literature 1: JP 2015-19728 A

### SUMMARY

### Technical Problem

Othello (registered trademark) and the game disclosed in the above-mentioned Patent Literature 1 are popularly played among a wide range of age groups as the rules of these games are very simple in that when two pieces of one player flank a piece of another player in a vertical, horizontal, or diagonal line, the piece of another player is in turn possessed by the one player, so that the game can be played without prior knowledge. On the other hand, the rules are so simple that there are limited numbers of tactics players can take, which leads to a problem that the players get bored readily.

In contrast, a lot of prior knowledge is required for playing Shogi and chess, as each piece has a different role and thus the rules of the game are complicated. Therefore, it is difficult for both adults and children to remember the role of each piece and understand the rules, which leads to a problem that longer time is required to enjoy the game. Similarly, the rules of Go are so detailed and complicated that not all people of a wide range of ages can easily enjoy the game.

Furthermore, only two players can play Go, Shogi, chess, and Othello (registered trademark), these games are not flexible in terms of the number of players.

The present disclosure has been made in view of the above, and an object thereof is to provide a game system, a game sheet, a game program, and a game device that can be easily enjoyed by people of a wide range of ages, hardly makes players bored even after consecutive matches, and can be played by various number of players.

### Solution to Problem

In order to solve the above-mentioned problems, a game system to be played by at least two players according to one aspect of the present disclosure comprises a game board provided with a plurality of scattered dots and a plurality of marks arranged at positions spaced from the plurality of dots, positioners to be arranged at any of the plurality of dots and assigned to each of the players, and boundary indicators made of flexible string material and used to linearly connect the positioners arranged at any of the plurality of dots among the plurality of positioners assigned to each player.

In the game system, a hole may be formed at each of the plurality of dots, and the positioners may be pins insertable into and removable from the hole. In the game system, the string material may be a cord made of fiber or rubber.

In the game system, a plurality of line segments connecting each of the plurality of dots to at least two other dots of the plurality of dots and arranged so as not to intersect each other may be drawn on the game board. In the game system, the plurality of marks may be placed one by one in any one of polygons formed by the plurality of line segments.

In the game board of the game system, any one of the plurality of dots and any two dots adjacent to the one dots may not be located on a single straight line.

A game sheet according to another aspect of the present disclosure is used in a game system to be played by at least two players and comprises a plurality of scattered dots, a plurality of line segments connecting each of the plurality of dots to at least two other dots of the plurality of dots and arranged so as not to intersect each other, and a plurality of marks placed one by one in any one of polygons formed by the plurality of line segments, the game sheet being designed to be used in a game where positioners assigned to each player are arranged at any of the plurality of dots, and each player obtains a territory defined by linearly connecting the positioners of the each player arranged at any of the plurality of dots among the plurality of positioners.

A game program according to yet another aspect of the present disclosure is executed by a game device designed for at least two players to play a game, the game device having a display unit, a control unit configured to control operations of the game device, and an input unit configured to transmit a signal corresponding to an action subjected to an object displayed on the display unit to the control unit, the game program comprising: a display controlling step of displaying a game board object provided with a plurality of scattered dots and a plurality of marks arranged at positions spaced from the plurality of dots, positioning objects to be arranged at any of the plurality of dots and assigned to each of the players, and boundary indication objects linearly connecting the positioning objects arranged at any of the plurality of dots among the plurality of positioning objects assigned to each of the players to indicate a defined territory; a turn order setting step of allowing one of the positioning objects assigned to each of the players to be in a movable state in a predetermined order; an object moving step of, when a predetermined first action is made on one of the positioning objects in the movable state and a predetermined second action is made on one of the plurality of dots satisfying a predetermined condition, moving the positioning object on which the first action is made to the dot on which the second action is made; and a boundary update step of updating the boundary indication objects based on a position of the positioning object moved at the object moving step.

In the game program, a plurality of line segments connecting each of the plurality of dots to at least two other dots of the plurality of dots and arranged so as not to intersect each other may be arranged on the game board object. In the game program, the plurality of marks may be placed one by one in any one of polygons formed by the plurality of line segments.

The game program may further comprise a setup step of determining arrangements of the plurality of dots such that any one of the plurality of dots and any two dots adjacent to the one dot are not located on a single straight line.

A game device executing a game designed for at least two players to play a game according to still another aspect of the present disclosure comprises a display unit, a control unit configured to control operations of the game device, and an input unit configured to transmit a signal corresponding to an action subjected to an object displayed on the display unit to the control unit, wherein the control unit may comprises: a display controlling component displaying a game board object provided with a plurality of scattered dots and a plurality of marks arranged at positions spaced from the plurality of dots, positioning objects to be arranged at any of the plurality of dots and assigned to each of the players, and boundary indication objects linearly connecting the positioning objects arranged at any of the plurality of dots among the plurality of positioning objects assigned to each of the players to indicate a defined territory; a turn order setting component allowing one of the positioning objects assigned to each of the players to be in a movable state in a predetermined order; an object moving component configured to, when a predetermined first action is made on one of the positioning objects in the movable state and a predetermined second actin is made on one of the plurality of dots satisfying a predetermined condition, move the positioning object on which the first action is made to the dot on which the second action is made; and a boundary update component configured to update the boundary indication objects based on a position of the positioning object moved by the object moving component.

### Advantageous Effect

According to the present disclosure, the territory acquired by each of the players is visualized by placing positioners assigned to the each player at a plurality of dots and connecting the positioners of the each player with boundary indicators, so that even children and elderlies can easily understand situations of the game, which allows people of all ages to readily enjoy the game.

Moreover, according to the present disclosure, the positioners of each of the players are linearly connected by the boundary indicators, so that the territories may have shapes that are not easily foreseeable from the arrangements of the plurality of dots. Therefore, each of the players can enjoy the game repeatedly without getting bored.

Furthermore, according to the present disclosure, various numbers of players may participate the game on a single game board by preparing the positioners and the boundary indicators assigned to each of the players.

### BRIEF DESCRIPTION OF DRAWINGS

FIG. 1 is a perspective view showing an appearance of a game system according to a first embodiment of the present disclosure.

FIG. 2 is a top view showing an example of a game board used in the game system according to the first embodiment of the present disclosure.

FIG. 3 is a perspective view of the game board according to the first embodiment of the present disclosure shown in a state prior to beginning the game.

FIG. 4 is a perspective view of the game board according to the first embodiment of the present disclosure shown in a state during the game.

FIG. 5 is a perspective view showing an appearance of a game system according to a second embodiment of the present disclosure.

FIG. 6 is a block diagram illustrating a schematic configuration of a game device according to a third embodiment of the present disclosure.

FIG. 7 is a schematic diagram showing an example of a screen displayed on the display unit shown in FIG. 6 at the beginning of the game.

FIG. 8 is a flowchart illustrating operations of the game device according to the third embodiment of the present disclosure.

FIG. 9 is a schematic diagram showing an example of an initial screen of the game displayed on the display unit shown in FIG. 6.

FIG. 10 is a schematic diagram showing an example of the turn order determination screen displayed on the display unit shown in FIG. 6.

FIG. 11 is a schematic diagram showing an example of the playing screen displayed on the display unit shown in FIG. 6.

FIG. 12 is a schematic diagram showing an example of the playing screen displayed on the display unit shown in FIG. 6.

FIG. 13 is a schematic diagram showing an example of the playing screen displayed on the display unit shown in FIG. 6.

FIG. 14 is a schematic diagram showing an example of the playing screen displayed on the display unit shown in FIG. 6.

FIG. 15 is a schematic diagram showing an example of the playing screen displayed on the display unit shown in FIG. 6.

FIG. 16 is a schematic diagram showing an example of the playing screen displayed on the display unit shown in FIG. 6.

### DETAILED DESCRIPTION

Hereinafter, a game system, a game sheet, a game program, and a game device according to embodiments of the present disclosure will be described with reference to the attached drawings. It is noted that the present disclosure is not limited to these embodiments. In the attached drawings, the same parts are designated by the same reference numerals.

The drawings referred to in the following description only schematically show shapes, sizes, and positional relationships to the extent that the content of the present disclosure can be understood. That is, the present disclosure is not limited to the shapes, sizes, and positional relationships illustrated in the drawings.

### First Embodiment

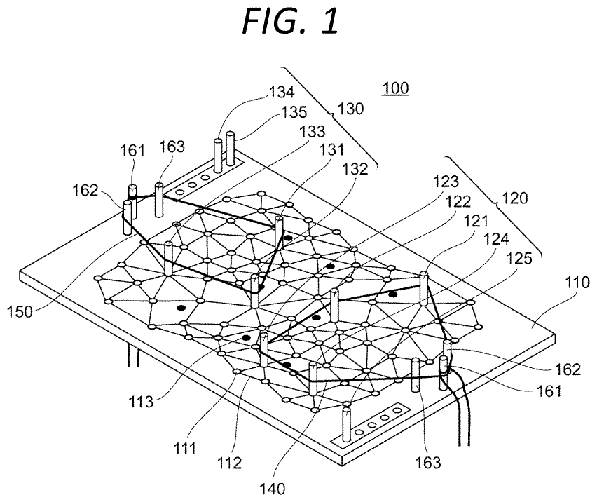

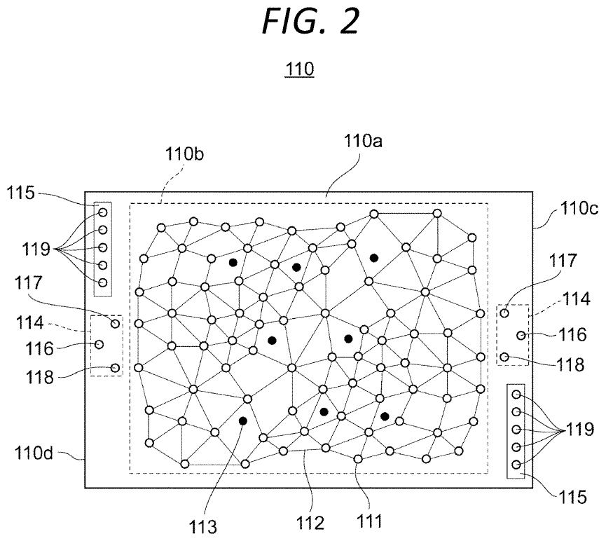

FIG. 1 is a perspective view showing an appearance of a game system according to a first embodiment of the present disclosure. FIG. 2 is a top view showing an example of a game board used in the game system. As shown in FIG. 1, a game system 100 according to the present embodiment is to be played by at least two players and comprises a game board 110, groups 120, 130 of movable pins 121-125, 131-135 respectively assigned to each of the players, and strings 140, 150 respectively used by each of the players. The game board 110 may also be provided with fixed pins 161-163 for winding the strings 140, 150.

The game board 110 is a plate made of, for example, wood, cork, plastic, metal, or the like. The shape and size of the game board 110 are not particularly limited. For example, it can have various sizes such as a smartphone size having a 5-inch screen, an A4 notebook size, and a duodecimo size. As for the shape, in addition to the rectangle illustrated in FIG. 2, various shapes including a polygon such as a square, a triangle, a pentagon, a hexagon, and an octagon, a circle, and an ellipse may be adopted. For example, the game board 110 having a quadrangular shape would be suitable for two to four players to play the game. Alternatively, the game board 110 having a circular shape would be suitable for various number of players as the players are readily and evenly positioned around the game board 110 regardless of the number of players to play the game. It is noted that the number of players capable of participating in the game is not limited by the shape of the game board 110.

As shown in FIG. 2, a plurality of dots 111 are dispersedly arranged in a field 110b on one main face 110a of the game board 110. Each of the dots 111 is formed with a hole into and from which the movable pins 121-125, 131-135 can be inserted and removed. The positions of the plurality of dots 111 are preferably determined so that any one of the plurality of dots and any two dots adjacent to the one dot are not located on a single straight line.

In addition, line segments (connection lines 112) each connecting two adjacent dots 111 to each other are drawn in the field 110b. That is, a large number of polygons (triangles and squares in FIG. 2) including some of the plurality of dots 111 as vertices and connection lines 112 as sides are drawn in the field 110b. In other words, a plurality of polygons each sharing one side and vertices at both ends thereof with adjacent polygons are arranged in the field 110b. Stated yet differently, a plurality of polygons that share intersections of the plurality of line segments at their ends are arranged in the field 110b.

The connection lines 112 indicate routes along which the players can move their movable pins to the dots 111 during the game. Preferably, the connection lines 112 extending from one of the dots 111 in different directions do not form a single straight line (that is, the angle formed by the connection lines 112 is not 180°).

Further, a plurality of (eight in FIG. 2) marks (goal marks 113) are drawn at positions different from the plurality of dots 111 in the field 110b. The goal marks 113 are preferably placed one by one in any one of polygonal (triangular or quadrangular in FIG. 2) areas with one of the plurality of dots 111 and two or more dots adjacent to the one dot being as vertices thereof.

In FIG. 2, only the hole corresponding to the position of the dots 111, the connection lines 112, and the goal marks 113 are displayed in the field 110b. However, the field 110b may additionally have a landscape, a map or an illustration as a background. Also, the arrangement of the dots 111 and the connection lines 112 may be appropriately determined according to the background landscape, map, illustration, and the like.

String adjustment areas 114 and movable pin retreat areas 115 are provided outside the field 110b on the main face 110a of the game board 110. The string adjustment areas 114 and the movable pin retreat areas 115 are preferably provided one for each player. In the present embodiment, the game board 110 is configured to be played by two players, and the string adjustment areas 114 and the movable pin retreat areas 115 are arranged in respective areas near two opposite sides 110c, 110d of the main face 110a.

In each of the string adjustment areas 114, a plurality of (three in FIG. 2) holes 116-118 into which the fixing pins 161-163 can be fitted are formed. The lengths of the strings 140, 150 can be adjusted by winding or hanging the strings 140, 150 around the fixing pins 161-163 fitted in the holes 116-118. In this way, the strings 140, 150 can be prevented from loosening in the field 110b, and the strings 140, 150 can be kept taut between the movable pins. Although the fixing pins 161-163 are detachable from the holes 116-118 in this embodiment, the fixing pins 161-163 may be permanently fixed to the game board 110.

A plurality of holes 117 into and from which the movable pins 121-125, 131-135 can be inserted and removed are formed in the movable pin retreat areas 115. These holes 117 are used to hold the movable pins 121-125, 131-135 that are not used in the field 110b. The diameter of the hole 116 and the diameter of the hole 117 (i.e., the diameters of the fixed pins 161-163 and the movable pins 121-125, 131-135) may be the same or different from each other.

The movable pins 121-125, 131-135 are arranged at the dots 111 on the game board 110 and serve as positioning means for defining the territories acquired by the players in the game. At least two movable pins are assigned to each player, and in the present embodiment, five movable pins 121-125 are assigned. The materials, shapes, and sizes of the movable pins 121-125, 131-135 are not particularly limited as long as they can be inserted into and removed from the holes provided at the dots 111 and the strings 140, 150 can be hung. For example, the material may be wood or plastic. Further, the shape may be a columnar shape as shown in FIG. 1, or may be provided with a constriction for facilitating the strings 140, 150 to be hung. Further, in order to clarify the owner (player) of the movable pins 121-125, 131-135, each of the groups 120, 130 of the movable pins may have an individually different color or marks.

The strings 140, 150 are flexible string material, and serve as boundary indicating means indicating boundaries defined by linearly connecting at least the movable pins 121-125, 131-135 assigned to each player, in other words, the territory of each player defined in accordance with the pins 121-125, 131-135. For example, in the state shown in FIG. 1, the territory of one player is defined by the string 140 hung on the movable pins 121-124 arranged at the dots 111 on the field 110b. Further, the territory of the other player is defined by the string 150 hung on the movable pins 131-133 arranged at the dots 111 on the field 110b. The shapes of the territories owned by the respective players and defined by the strings 140, 150 are polygons with the movable pins and the fixed pins of respective players being as vertices thereof when viewed above the upper surface of the game board 110. It is noted that depending on the thicknesses and shapes of the movable pins and the fixed pins, the shapes of the territories defined by the strings 140, 150 may be polygons with rounded corners.

The material of the strings 140, 150 is not particularly limited, and may be formed of fibers (threads, wools, or the like) or rubber having high elasticity. The latter case has an advantage that it is easy to maintain a state where the strings 140, 150 are taut in the field 110b without frequently adjusting the lengths of the strings 140, 150 in the string adjustment areas 114. It is more preferable that the strings 140, 150 have colors different from each other in order to easily identify the territories of the players.

Next, a game using the game system 100 will be discussed. The game system 100 is used for plying a territory acquisition type of game in which basically a plurality of players take turns and move the movable pins 121-125, 131-135 assigned to the players in the field 110b from one dot 111 to another dot 111 along the connection line 112 to expand the territories defined by the strings 140, 150. The rule for moving the movable pins 121-125, 131-135, the number of the movable pins, and the rule for deciding the winner may be appropriately determined.

Hereinafter, an example of a way of playing the game with using the game system 100 will be discussed. In this example, five movable pins 121-125, 131-135 are assigned to each player, and whoever first gets a territory defined by the strings 140, 150 that surrounds any six goal marks 113 of the eight goal marks 113 will win the game.

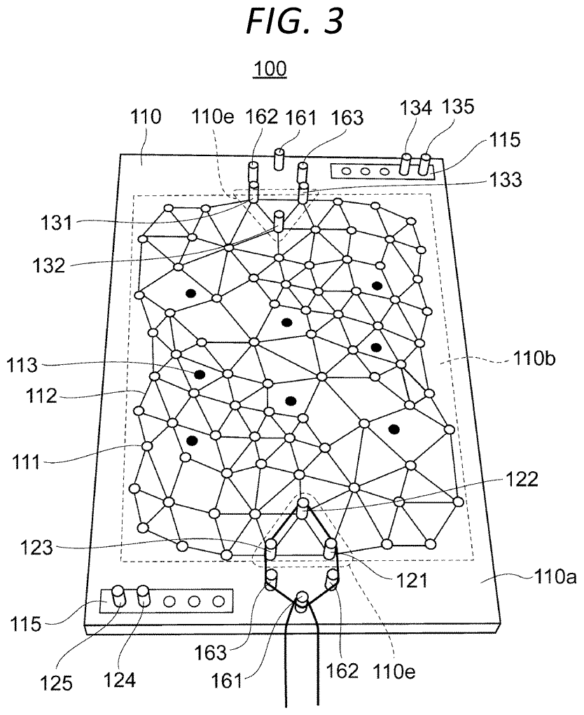

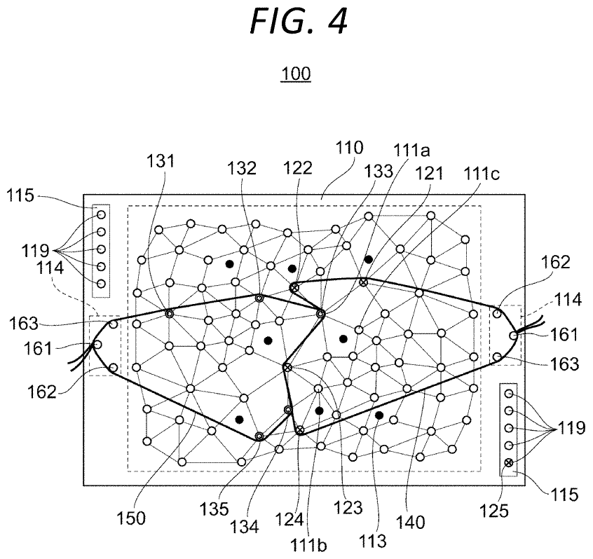

FIG. 3 is a perspective view showing a state of the game system 100 before beginning the game. FIG. 4 is a perspective view showing a state where the game is being played. In preparation for the game, each player winds both ends of the string 140, 150 around the fixed pins 161-163 of the player's own side, inserts the three movable pins 121-123, 131-133 to the holes formed at the dots 111 of the starting areas 110e of the player's side, and hangs the strings 140, 150 on these movable pins 121-123, 131-133. The remaining movable pins 124, 125, 134 and 135 are left in the player's own movable pin retreat areas 115. In FIG. 4, upper ends of the movable pins 121-125 are marked with “X”, and upper ends of the movable pins 131-135 are marked with “O”.

After determining the order of play among the players, the game begins. The player in turn order can move the movable pin having been arranged in the field 110b, by one step along the connection line 112, which may be repeated for a predetermined number of times (for example, twice). When the movable pin is moved, the string 140, 150 is also moved together with the movable pin to define a player's new territory. Further, instead of moving the movable pin by one step in the field 110b, a movable pin held in the movable pin retreat area 115 may be moved to any dot 111 within the player's territory. In this instance, there may be rules that if the player's own string 140, 150 is situated right above one of the dots 111 and 50% or more of the dots 111 is visually assumed to be in the player's own territory, a movable pin may be moved from the movable pin retreat area 115 to the one of the dots 111, whereas if 50% or more of the dots 111 is not in the player's own territory, such a movable pin cannot be moved to that dot, namely that when a movable pin is newly introduced in the field 110b, the new movable pin cannot be placed so as to directly expand the player's own territory. Further, there may be a rule that only one movement of a movable pin is allowed in the very first turn.

By alternately repeating the play in this way, each player expands the player's own territory. When the players' territories approach each other, each player may advance a movable pin to a dot 111 located inside the opponent player's territory to deform the opponent player's territory. FIG. 4 shows a state where the player on the left side has moved the movable pin 133 to the dot 111a, thereby causing the opponent player's (one on the right side) territory to dent. In this way, when the territories of the players come into contact with each other, the territory of each player is defined not only by the player's own move and fixed pins but also by the other players' move and fixed pins, so that the shape of the territory may become a concave polygon.

When the respective territories are complicatedly intricate with each other, a movable pin on the field 110b may fall into a state where it cannot move forward and backward. For example, when the player on the right side of FIG. 4 moves the movable pin 123 to the dot 111b in the next turn, the movable pin 133 of the player on the left side is surrounded by other movable pins and loses an available dot to move. In such a case, the player on the right side can retract the opponent player's movement pin 133 (remove it from the field 110b) to reduce the opponent player's territory. The player on the left side who has forced to retreat the movement pin 133 returns the movement pin 133 to the movement pin retreat area 115, and after the next turn, may use the movement pin 133 again by placing it at any dot 111 in the player's territory. Whether or not the dot 111 is located within the player's own territory may be determined by, for example, visually assuming if 50% or more of the dots 111 is contained within the player's own territory (the area defined by the string).

Whoever first gets the territory containing six of the eight goal marks 113 drawn in the field 110b will be the winner of the game. The game may also end up when any of the players declares a give-up. In this case, whoever owns the largest number of goal marks 113 within the player's own territory will be the winner of the game.

As described above, according to the first embodiment of the present disclosure, the game progresses with easy operations and simple rules that the movable pin are moved on the field 110b and the territories are defined by the string stretched between the movable pins, so that people of all ages including children and adults can easily start and enjoy the game.

Further, according to the present embodiment, the territory of each player is visualized by the string, so that the situation of the game can be easily understood even when the territories of the players are complicatedly intricate with each other. Therefore, it is possible to prevent the players from being difficult to see the circumstance of the game and thus getting bored, so that each player easily continues the game to the end.

Further, according to the present embodiment, the territory of each player is defined by the string stretched in a straight line between the movable pins, so that the territory may have a shape that is hardly foreseeable from the polygon formed by the pre-arranged dots 111 and the pre-drawn connection lines 112 on the board, which makes the game more fun. In particular, when the players' territories are in contact with each other, a move of one player (movement of the movable pin) affects not only the one player's own territory but also the shape of the other player's territory, so that the future aspect is hardly anticipated.

That is, in order to read the development of the game, the player needs to imagine the shapes of the territories defined by the player's own and other players' movable pins and strings besides the polygon formed by the connection lines 112. Therefore, the player can enjoy the game repeatedly without getting bored.

Since it is considered that repeating such thoughts is effective for intellectual abilities and prevention of dementia, the game system according to the present embodiment is suitable for not only an entertainment product, but also a skill development tool for children and a prevention tool for dementia.

Further, according to the present embodiment, not only two people but various numbers of people can enjoy the game. Even if the same game board is used, it is sufficient to prepare strings and movable pins depending on the number of players.

Further, according to the present embodiment, the configuration and the basic rules of the game system 100 are simple, so that the player can freely set additional rules. Therefore, the variation of the game can be easily expanded.

In the above-described embodiment, various game systems can be configured by increasing the types of the plurality of dots 111, the connection lines 112, and the goal marks 113 provided in the field, or changing the design of the movable pins. For example, by drawing an illustration of a historical or fictional story on the field, or adopting historical characters or characters that appear in a fictional story in the design of the movable pin to make the game more narrative, the game system variation can be increased.

It is noted that, in the above-described first embodiment, the connection lines 112 that connect pairs of two dots 111 are drawn in the field 110b of the game board 110. However, the connection lines 112 may not be drawn. In this case, it may be appropriate to make a rule such that the movable pins can be moved to all the adjacent dots 111, or can be moved to all the dots 111 located within a predetermined range.

Moreover, in the above-described first embodiment, three movable pins 121-123, 131-133 are arranged in the field 110b at the beginning of the game. However the number of movable pins arranged in the field 110b at the beginning may be at least one. That is, the game may begin with a state where the territory of each player is defined by a string hung on one movable pin and one fixed pin. Alternatively, all the movable pins assigned to each player may be arranged in the field 110b from the beginning of the game.

Further, in the above-described first embodiment, the string 140, 150 of each player is wound and held around three fixing pins 161-163. However, the number of fixing pins holding each string 140, 150 may be one or two. Alternatively, the fixed pins may not be provided and the game may be played only with the movable pins. In this case, the number of movable pins assigned to each player is at least three. The string 140, 150 of each player forms a polygon connecting the at least three movable pins assigned to each player, and the territory of each player defined by the string 140, 150 can move around on the field 110b.

### Second Embodiment

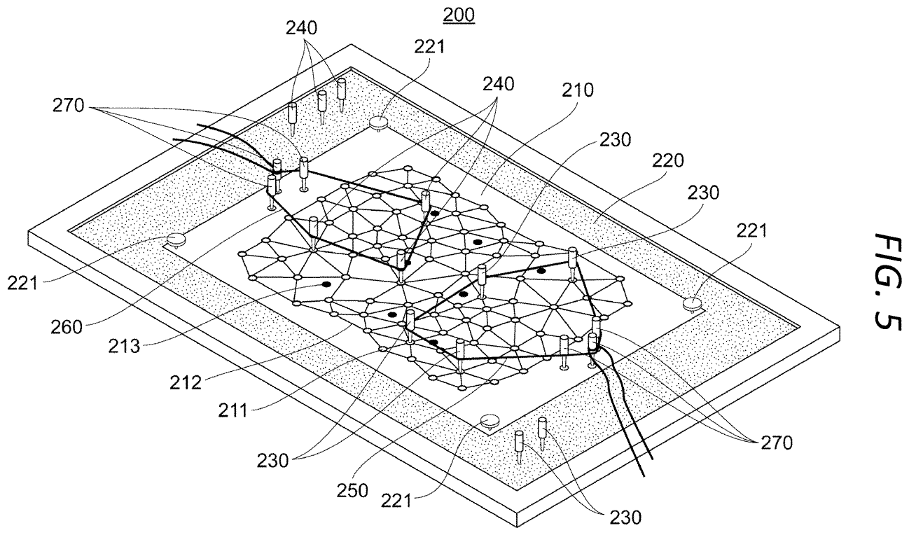

FIG. 5 is a perspective view showing an appearance of a game system according to the second embodiment of the present disclosure. As shown in FIG. 5, a game system 200 according to the present embodiment is provided with a game sheet 210 attached to the board 220 with pins 221, a plurality of pins 230, 240 assigned by a predetermined number to each player, strings 250, 260 used to define the players' territories, and a plurality of pins 270 for holding the strings 250, 260 and adjusting the lengths of the strings 250, 260 in a field.

The game sheet 210 is a sheet formed of paper, thin vinyl or the like. On one surface of the game sheet 210, a plurality of dots 211, connection lines 212 connecting these dots 211, and a plurality of goal marks 213 are printed. Similar to the first embodiment, the area in which the plurality of dots 211 and the connection lines 212 are printed or drawn is the field of the game.

The board 220 is a plate that supports the game sheet 210. The material of the board 220 is not particularly limited as long as it is a material that can be pierced by the pins 221, 230, 240, such as cork, wood, and styrofoam board.

The plurality of pins 230, 240 are inserted into the dots 211 printed or drawn on the game sheet 210, and serve as positioning means for defining the territories acquired by the players in the game. The colors of the pins 230, 240 may be different for each player.

The strings 250, 260 are of flexible string material, and serve as boundary indicating means indicating boundaries defined by linearly connecting the plurality of pins 230, 240 assigned to each player, in other words, the territory of each player defined in accordance with the pins 230, 240.

Similar to the game system 100 according to the first embodiment, the game system 200 as described above is used for plying a territory acquisition type of game in which a plurality of players take turns and move the pins 230, 240 assigned to the players on the game sheet 210 to expand the territories defined by the strings 250, 260.

According to the second embodiment of the present disclosure described above, it is possible to play the game by using general-purpose products for components other than the game sheet 210. Therefore, it is convenient to carry and enables to easily enjoy the game anywhere.

In addition, according to the present embodiment, the positions of the dots 211, the connection lines 212, and the goal marks 213 printed or drawn on the game sheet 210 are changed, or the designs thereof are changed, so that various types of game systems can be configured.

As a variation of the second embodiment, the plurality of pins 230, 240 may be configured to have magnets. In this case, by attaching the game sheet 210 on a steel board, the game can be played without making a pin hole in the game sheet 210.

### Third Embodiment

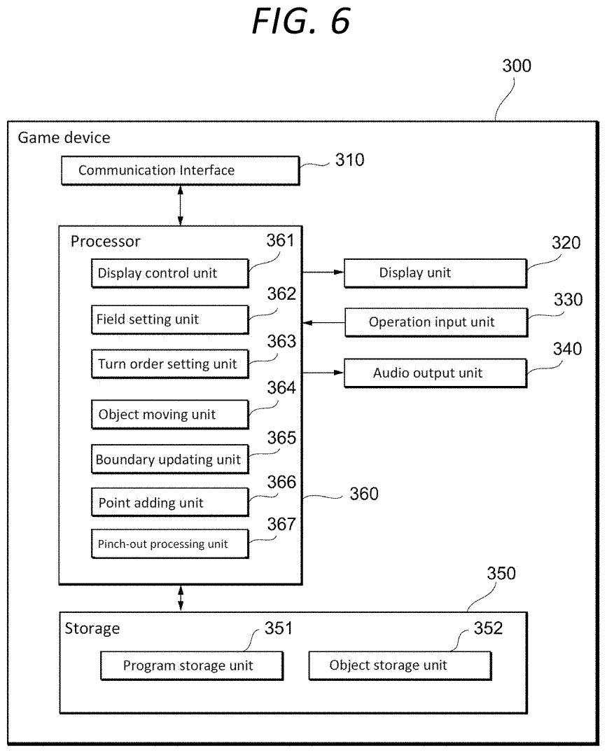

FIG. 6 is a block diagram illustrating a schematic configuration of a game device according to a third embodiment of the present disclosure. The game device according to the present embodiment can be configured by a general-purpose terminal device such as a personal computer, a laptop computer, a tablet device, a smartphone, or a home-use game console. Hereinafter, a case where a game device 300 is configured by a smartphone will be described by way of example, but the present disclosure is not limited thereto.

As shown in FIG. 6, the game device 300 according to the present embodiment is provided with a communication interface 310, a display unit 320, an operation input unit 330, a voice output unit 340, a storage unit 350, and a processor 360.

The communication interface 310 connects the game device 300 to a communication network, and communicates with other devices connected to the communication network. The communication interface 310 is configured by using, for example, a soft modem, a cable modem, a wireless modem, an ADSL modem or the like. The communication network is configured by, for example, an Internet line, a telephone line, a LAN, a mobile communication network, WiFi (Wireless Fidelity), Bluetooth (registered trademark), or a combination thereof, and may be wired, wireless, or a combination thereof.

The display unit 320 is, for example, a display including a drive unit and a display panel formed of liquid crystal or organic EL.

The operation input unit 330 is, for example, an input device such as an operation button or a touch panel provided on the display unit 320, and inputs a signal according to an operation performed from the outside to the processor 360. It is noted that when the game device is composed of a personal computer or a laptop computer, a pointing device such as a mouse may be used as the operation input unit 330. The audio output unit 340 is a general sound player.

The storage unit 350 is a computer-readable storage medium such as a semiconductor memory including a ROM or a RAM. The storage unit 350 includes a program storage unit 351 and an object storage unit 352. The program storage unit 351 stores an operating system program, a driver program, an application program that executes various functions, various parameters used during the execution of these programs, and the like. A game program to be played by two or more players may be recited by way of example of an application program stored in the program storage unit 351.

The object storage unit 352 stores various objects displayed on the display unit 320 during execution of the game program. Game board objects that include a plurality of dots that form the field displayed on the display unit 320, connection lines that connect these dots, and goal marks to be acquired during the game, pieces that serve as positioning objects and are assigned to each player, and boundary lines that serve as boundary indication objects that define territories acquired by the players by connecting at least pieces of each player may be recited by way of example of the objects.

Further, the object storage unit 352 may store an image of the background of the field. For example, as the background of the field, an image of a natural landscape, a landscape associated with a historical fact, a ruin, a historical building, or the like may be displayed. By so doing, the pieces, the boundary lines, and the goal marks remind the players of the meaning and role according to the background, so that it is possible to give the game a story and a sense of realism and make the game more interesting.

The processor 360 is configured, for example, by using a CPU (Central Processing Unit), and reads various programs stored in the program storage unit 351 to integrally control each unit of the game device 300, and realizes various functions to progress the game on the game device 300. The function unit realized by the processor 360 executing the game program stored in the program storage unit 351 includes a display control unit 361, a field setting unit 362, a turn order setting unit 363, and an object moving unit. 364, a boundary updating unit 365, a point adding unit 366, and a pinch-out processing unit 367.

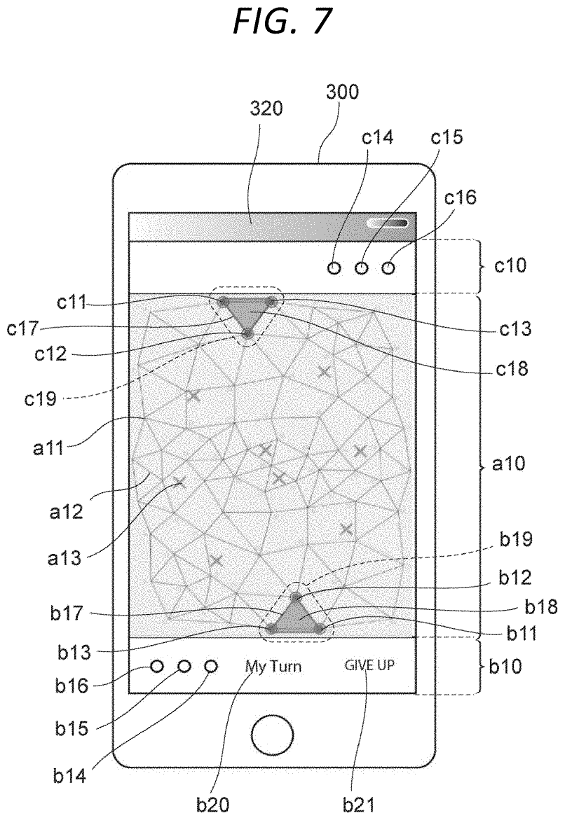

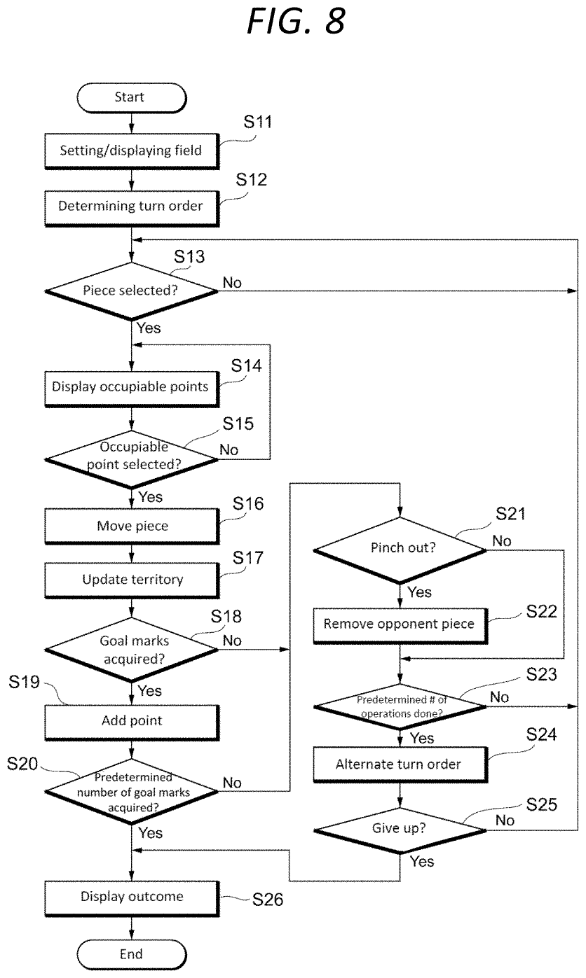

The display control unit 361 controls the display unit 320 to display various information and objects. FIG. 7 is a schematic diagram showing an example of a screen displayed on the display unit 320 at the beginning of the game. FIG. 7 shows a screen where two players are playing a game on a single game device 300. As shown in FIG. 8, the display unit 320 is provided with a field a10 and command display areas b10, c10 for displaying the turn order, the game situation, commands to each player, and the like. In the field a10, a plurality of dots a11 are scattered and arranged, and a polygon (triangle or quadrangle) formed by connecting the plurality of dots a11 with each other by connection lines a12, and predetermined numbers of goal marks a13 arranged in the polygons.

Further, the display section 320 displays pieces b11-b16, c11-c16 assigned to each player, and boundary lines b17, c17 connecting the pieces of each player. The areas defined by the boundary lines b17, c17 are the territories b18, c18 of the players and are shaded or color-coded.

In addition, as a background of these objects, the offensive and defensive battles of countries that was historically carried out at the Palmyra ruins, or the country acquiring battle of the daimyo of the Sengoku period of Japan may be displayed. In this case, for example, the dots a11 represent geographical marks such as a mountain, a river, or a valley, the pieces b11-b16, c11-c16 represent armies of respective countries battling each other, the boundary lines b17, c17 represent the acquired territories, and goal marks a13 represent castles, so that the game has a storyline and players can enjoy it more.

In FIG. 7, six pieces are assigned to each player. At the beginning of the game, three pieces b11-b13, c11-c13 of the pieces assigned to each player are arranged at starting areas b19, c19 located at both ends of the field a11. The remaining pieces b14-b16, c14-c16 are displayed in the respective command display areas b10, b20.

In the command display areas b10, b10, texts indicating the turn order (for example, the texts displayed at the area b20) and an icon (for example, a text icon b21) to be operated by the player to indicate an intention to give up the game are additionally displayed.

The field setting unit 362 sets the arrangement of the game board objects in the field. Specifically, the field setting unit 362 sets the number and arrangement of the plurality of dots a11 to be placed in the field. Further, the field setting unit 362 sets the arrangement of the connection lines a12 that connect the plurality of dots a11. Specifically, the field setting unit 362 preferably determine positions of the plurality of dots a11 so that one dot a11 and two other dots a11 adjacent to the one dot a11 are not colinear. Further, the field setting unit 362 determines the arrangement of the connection lines a12 so as to prevent the connection lines from intersecting each other, and preferably prevent the connection lines extending from the same dot in different directions from being colinear (that is, the angle formed by these connection lines is not 180 degrees). Furthermore, the field setting unit 362 arranges the plurality of goal marks a13 one by one in the plurality of polygons formed by the connection lines a12.

The arrangement of the game board objects set by the field setting unit 362 may be the same each time or may be different each time. Also, the number and arrangement of each object may be changed depending on the level of the player. Alternatively, the arrangement of the dots a11 and the connection lines a12 may be set in accordance with the background (scenery, map, illustration, or the like) displayed according to the story of the game.

The turn order setting unit 363 sets the turn order of a plurality of players participating in the game, and allows the pieces owned by the player in turn order to be moved. When a predetermined operation is performed on a piece in a movable state and a dot satisfying a predetermined condition among the plurality of dots, the object moving unit 364 performs a process of moving the piece to the position according to the operations.

The boundary updating unit 365 updates the territory acquired by each player by updating the boundary lines of each player based on the position of the piece of each player in a real time manner. The point adding unit 366 performs a process of adding a point to the player satisfying a predetermined condition and determining the winner. By way of example, when the boundary of the player is updated by the boundary updating unit 365 and a goal mark is newly included in the territory of the player, the point adding unit 366 adds a point to the player. The pinch-out processing unit 367 performs a process of excluding a piece falling into a predetermined situation from the field.

A territory acquisition type of game is played on such a game device 300, where a plurality of players alternately move own pieces b11-b16, c11-c16 from a dot a11 to another dot a11 along a connection line a12 in a field a11) to expand territories b18, c18 defined by the boundary lines b17, c17. The outcome of the game may be arbitrarily determined. In the present embodiment, whoever first owns a territory surrounding a predetermined number (for example, 6) of the plurality of (eight in FIG. 7) goals marks a13b drawn in the field a11) is the winner.

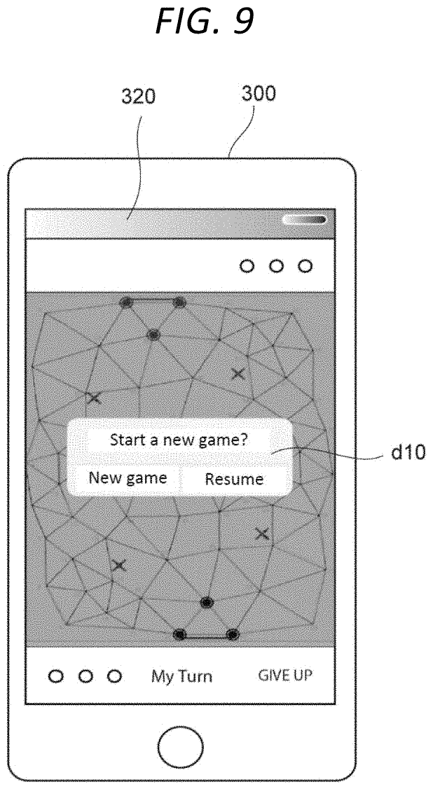

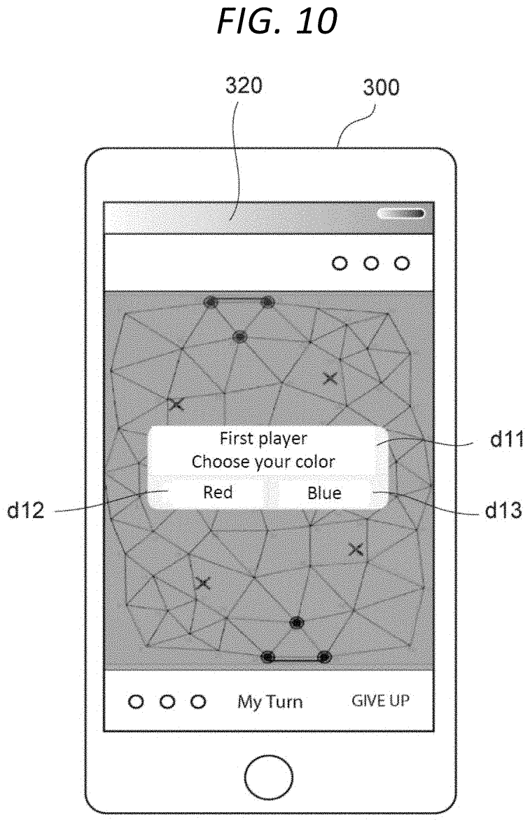

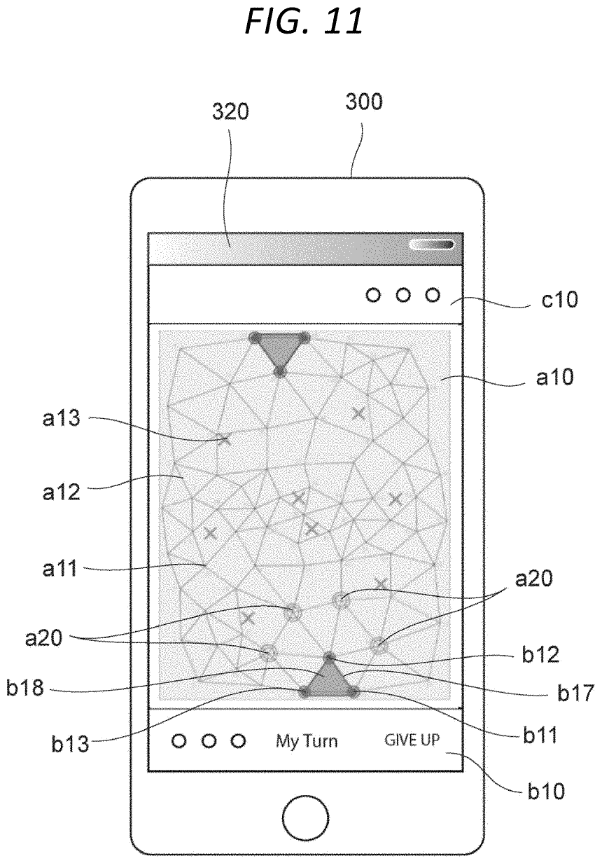

Next, the operations of the game device 300 will be discussed. FIG. 8 is a flowchart showing the operations of the game device 300. FIGS. 9 to 18 are schematic views illustrating screens displayed on the display unit 320 of the game device 300. Of these, FIG. 9 shows a game initial screen, FIG. 10 shows a turn order determination screen, and FIGS. 11 to 16 show playing screens.

First, at step S11, the game device 300 sets the field a10 for playing the game and displays it on the display unit 320. Specifically, the field setting unit 362 determines the numbers and positions of the dots a11, the connection lines a12, and the goal marks a13, and the display control unit 361 displays these objects and objects such as a background on the display unit 320.

Here, the game device 300 may have a function of resuming the game after the game is once interrupted. In this case, when the game application is launched on the game device 300, a window d10 appears on the display unit 320 of the game device 300 to select whether to start a new game or resume the interrupted game, as shown in FIG. 9. The field setting unit 362 sets various objects according to a predetermined operation on the window d10 (for example, a tap operation on the text of “start a new game” or “resume the previous game”).

At subsequent step S12, the game device 300 sets the turn order of the players participating in the game. Specifically, as shown in FIG. 10, the display control unit 361 allows the display unit 320 to display the turn order selection window d11, and the turn order setting unit 363 activates the pieces b11-b16, c11-c16 and the command display areas b10, c10 displayed on the display unit 320 in an order corresponding to the predetermined operation (for example, a tap operation on the “red” text icon d12 or the “blue” text icon d13)” and displays texts (for example, text display area b20) indicating the turn order in the command display areas b10, c10 (see FIG. 7).

At step S13, the game device 300 determines whether or not a predetermined operation (for example, a tap operation for one piece) of selecting one of the pieces of the player in turn order is performed.

When the operation of selecting one of the pieces is not performed (step S13: No), the game device 300 stands by until the operation of selecting the piece is performed. On the other hand, when the predetermined operation is performed on any of the pieces (step S13: Yes), the game device 300 displays the dots a11 to which the selected piece can move (step S14). For example, as shown in FIG. 11, when the piece b12 arranged in the field a10 is selected, the object moving unit 364 identifies any dots where no other piece is arranged from the dots connected to the dot a11 where the piece b12 is located by one of the connection lines a12 (hereinafter also referred to as one-step-ahead dots) as occupiable dots a20, and the display control unit 361 allows the occupiable dots a20 to be displayed on the display unit 320 in a predetermined manner. Specifically, a display control such as changing the color of the occupiable dots a20 or blinking the occupiable dots is performed.

At subsequent step S15, the game device 300 determines whether or not a predetermined operation of selecting one of the occupiable dots (for example, a tap operation on one of the occupiable dots) has been performed. When none of the occupiable dots is selected (step S15: No), the process returns to step S14. On the other hand, when any of the occupiable dots is selected (step S15: Yes), the game device 300 moves the piece selected at step S13 to the occupiable dot selected at step S15 (step S16).

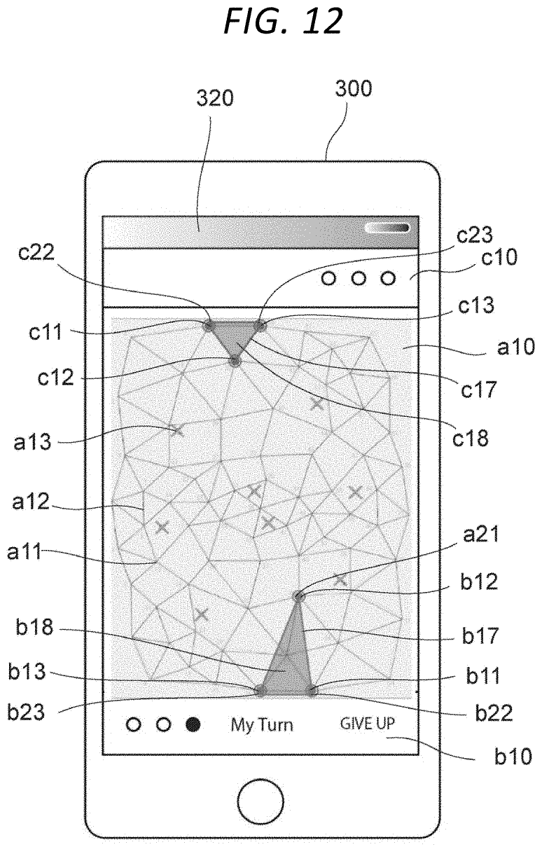

At subsequent step S17, game device 300 updates the player's territory based on the moved piece. For example, as shown in FIG. 12, when the piece b12 moves to the one-step-ahead dot a21 from the state shown in FIG. 11, the boundary lines b17 are updated with the piece b12 after being moved and the other pieces b11, b12 placed in the field a11) being as vertices thereof, so that a new territory b18 is defined. Here, the boundary lines b17, c17 are fixed to two dots b22, b23, c22, c23 near the end of the field in the starting areas b19, c19, and the boundary lines b17, c17 are always connected to the dots b22, b23, c22, c23.

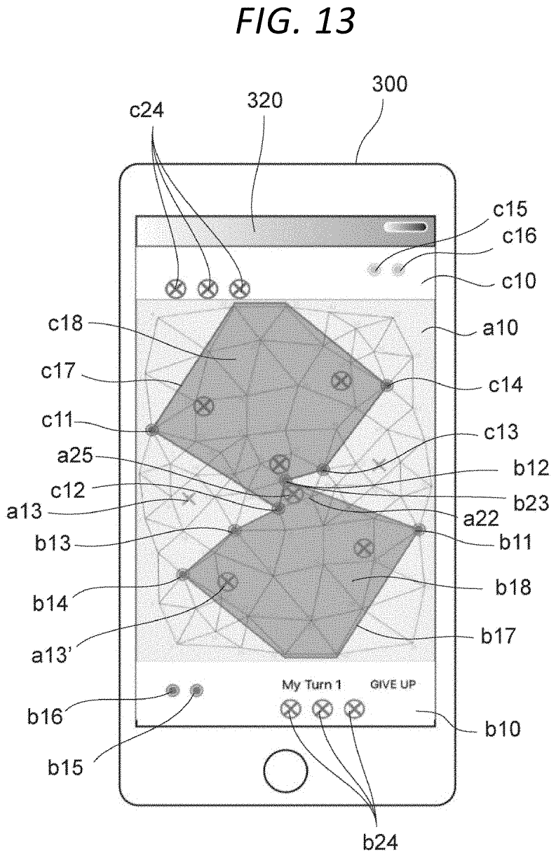

Further, as the game progresses, the territories of the players come into contact with each other. Under the circumstance, when the player's piece in turn order moves into the opponent player's territory, the opponent player's territory is also updated according to the position of the moved piece. For example, as shown in FIG. 13, when the piece b12 moves from the dot a22 to the dot a23, the boundary line c17 connecting the opponent player's pieces c12, c13 is dented by the piece b12, and the area of the opponent player's territory c18 is decreased.

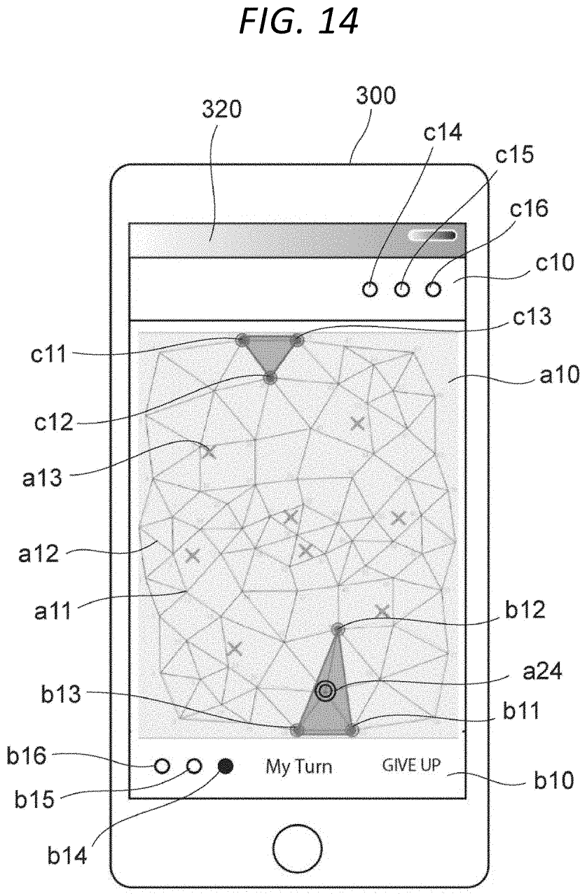

Further, when, at step S13, the piece (for example, piece b14) arranged in the command display area b10 is selected as shown in FIG. 14, the object moving unit 364 identifies, at step S14, a dot where no other piece is arranged from the dots within the player's own territory in the field 10a as an occupiable dot a24, and the display control unit 361 performs a display control by allowing the occupiable dot a24 to change its color or blink. In this case, the boundary line b17 and the territory b18 are not updated. It is noted that the dot a11 located on the boundary line b17 may be considered to be included in the territory (that is, the pieces arranged in the command display area b10 may be moved to the dot a11), or may be considered not to be included in the territory.

At step S18, the game device 300 determines whether or not a new goal mark has been acquired by the territory updated at step S17. For example, as shown in FIG. 13, when the territory b18 updated by moving the piece b12 from the dot a22 to the dot a23 newly includes a goal mark a25, the goal mark a25 is determined as acquired by the player. At this state, since the polygon formed by the connection lines surrounding the goal mark is located at the end of the boundary line, only a part of the polygon may be covered by the player's territory. In this case, if a predetermined ratio (for example, 50%) or more of the polygon is covered by the player's territory, the goal mark situated in the polygon may be considered to be acquired by the player. Alternatively, if the entirety of the above-mentioned polygon is covered by the player's territory, or even a part of the above-mentioned polygon is covered by the player's territory, the goal mark situated in the polygon may be considered to be acquired by the player.

When a goal mark is newly acquired (step S18: Yes), the game device 300 adds a point to the player in turn order (step S19). It is noted that in the field 10a, as shown in FIG. 13, a specific display control (adding a specific color, reversing, encircling, or the like) may be performed with respect to the goal mark a13′ already acquired by any player, so that it can be distinguished from the goal marks a13 which have not been obtained by any player. Further, the objects b24, c24 of the acquired goal marks and the number of the acquired goal marks may be displayed in the command display areas b10, c10 of each player. Subsequently, the process proceeds to step S20. On the other hand, if a goal mark is not newly acquired (step S18: No), the process proceeds directly to step S20.

At step S20, the game device 300 determines whether or not the player in turn order has acquired a predetermined number (six in the present embodiment) of goal marks. If the predetermined number of goal marks have been acquired (step S20: Yes), the process proceeds to step S26. On the other hand, if the predetermined number of goal marks have not been acquired (step S20: No), the process proceeds to step S21.

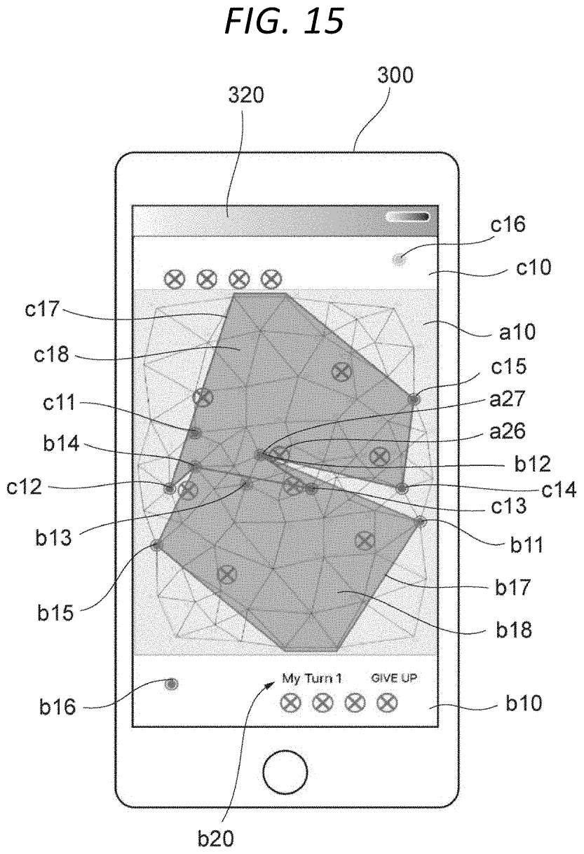

At step S21, the game device 300 determines whether or not a pinch-out has occurred due to the movement of the piece at step S16. Here, the term “pinch-out” refers to a situation where escape routes of an opponent player's piece are closed off and the opponent player's piece is surrounded by the piece(s) and the boundary line(s) of the player in turn order, thereby removing the surrounded piece from the field. For example, FIG. 15 shows a state where the piece b12 moves from the dot a25 to the dot a26 to cut off the escape routes of the opponent player's piece c13 and surround the piece c13 with the pieces b12, b14 and the boundary line b17.

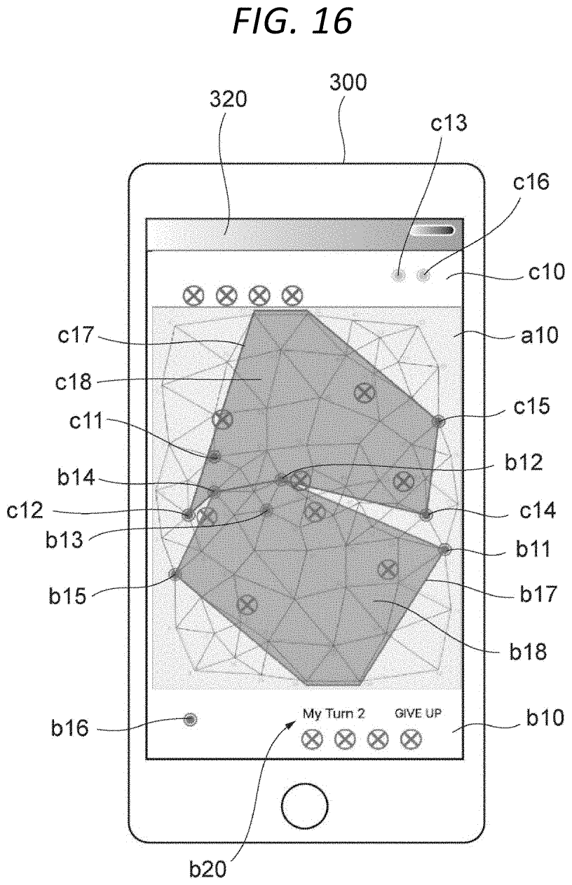

When the pinch-out occurs (step S21: Yes), the game device 300 removes the surrounded opponent player's piece (piece c13 in FIG. 15) from the field 10a, and place it in the opponent player's command display area (the command display area c10 in FIG. 15) (step S22). As shown in FIG. 16, after the pinch-out, the territory of the opponent player is reduced. The opponent player's piece c13 that has been pinched out can be reused and placed at any dot a11 in the opponent player's territory when the opponent player is in turn order. Subsequently, the process proceeds to step S23. On the other hand, if the pinch-out has not occurred (step S21: No), the process proceeds directly to step S23.

At step S23, the number of operations for the pieces (operations of moving the pieces situated in the field a10 by one step, or moving a piece situated in the command display area b10 to any dot in the own territory b18) in this turn order is determined to reach a predetermined number of times. For example, when the number of operations perfumed for the pieces is set to two in one turn order, one piece may be moved by two steps, or two different pieces may be moved by one step each. It is noted that, as shown in FIGS. 15 and 16, the number of operations capable of being performed for the pieces may be displayed in in the text display area b20 of the command display area b10.

If the number of operations for the piece has not reached the predetermined number of times (step S23: No), the process returns to step S13. On the other hand, if the number of operations for the piece has reached the predetermined number of times (step S23: Yes), the game device 300 alternates the turn order (step S24).

In the following step S25, the game device 300 determines whether or not an operation of indicating an intention to give up the game is performed by the player in turn order after the alternation. Specifically, it is determined whether or not a predetermined operation (for example, a tap operation) is performed on the text icon b21 in the command display area (for example, the command display area b10) of the player in turn order.

If the operation of indicating an intention to give up the game is not performed (step S25: No), the process proceeds to step S13. On the other hand, if the operation of indicating an intention to give us the game is performed (step S25: Yes), the process proceeds to step S26.

The game progresses by repeating the above steps S12 to S26 to allow the players to sequentially play. At step S26, the game device 300 displays the result of the game on the display unit 320. Regarding the determination of the win or lose, the player who first acquires the predetermined number of goal marks at step S20 is regarded as the winner. Alternatively, when the operation of indicating an intention to give up is performed at step S25, the player performing the operation of indicating an intention to give up is regarded as the loser. Alternatively, when an intention to give up is indicated, the game may be drawn. Then, the operation of the game device 300 ends.

As described above, according to the third embodiment of the present disclosure, the game progresses, similar to the first embodiment, with operations and rules that the pieces are moved in the field and the territories are defined by the straight lines (boundary lines) connecting the pieces, so that people of all ages, from children to adults, can enjoy the game.

Further, according to the third embodiment of the present disclosure, since the game device 300 is configured by a general-purpose terminal device, such as a smartphone, and the game program, the program allows the materials and arrangements of various objects, the designs of the background image, the story of the game, the interface design, the rules and difficulty of the game, and the like to be changed easily. As a result, the variations of the game can be increased while maintaining the basic playing method and rules of the game unchanged. Therefore, the players can play it repeatedly without getting bored.

In the third embodiment, the case where two players play on one game device 300 has been described. However, the number of players participating in the same game device 300 is not limited and three or more players can play the game. Alternatively, one of the two players may be simulated by the game device 300 itself.

Alternatively, a plurality of game devices 300 may be connected to a communication network, and one player may operate one game device to compete online.

Further, in the third embodiment, the boundary line b17, c17 of each player is fixed to two dots b22, b23, c22, c23 near the player's own command display area b10, c10. However, it may be filed to one dot for each boundary line b17, c17. Alternatively, the boundary line b17, c17 of each player may not be fixed to a specific dot. In this case, at least three pieces are assigned to the boundary line b17, c17 of each player. The territories b18, c18, which are polygons formed by at least three pieces assigned to each player and are defined by the boundary lines b17, b18, can move to any positions in the field a10.

The present disclosure is not limited to the above-described first to third embodiments and variations thereof, but may be modified in many ways by appropriately combining a plurality of constituent elements disclosed in the above-described first to third embodiments and the variations thereof. For example, some constituent elements may be removed from the first to third embodiments and the variations thereof, or some constituent element of the first to third embodiments and the variations thereof may be appropriately combined.
100,200 game system
110 game board
110a main surface
110b field
110c, 110d sides
110e starting area
111, 111a to 111c, 211 dots
112, 212 connection line
113,213 goal mark
114 string adjustment area
115 movable pin retreat area
116, 118 holes
120, 130 movable pin group
121-125, 131-135 movable pin
140, 150, 250, 260 string
161-163 fixed pin
210 game sheet
220 board
221, 230, 240, 270 pin
300 game device
310 communication interface
320 display unit
330 operation input unit
340 audio output unit
350 storage
351 program storage unit
352 object storage unit
360 processor
361 display control unit
362 field setting unit
363 turn order setting unit
364 object moving unit
365 boundary updating unit
366 point adding unit
367 pinch-out processing unit

1. A game system to be played by at least two players, comprising:
a game board provided with a plurality of scattered dots and a plurality of marks arranged at positions spaced from the plurality of dots;
positioners to be arranged at any of the plurality of dots and assigned to each of the players; and
boundary indicators made of flexible string material and used to linearly connect the positioners arranged at any of the plurality of dots among the plurality of positioners assigned to each player.

2. The game system according to claim 1, wherein
a hole is formed at each of the plurality of dots, and
the positioners are pins insertable into and removable from the hole.

3. The game system according to claim 1, wherein the string material is a cord made of fiber or rubber.

4. The game system according to claim 1, wherein a plurality of line segments connecting each of the plurality of dots to at least two other dots of the plurality of dots and arranged so as not to intersect each other are drawn on the game board.

5. The game system according to claim 4, wherein the plurality of marks may be placed one by one in any one of polygons formed by the plurality of line segments.

6. The game system according to claim 1, wherein any one of the plurality of dots and any two dots adjacent to the one dots are not located on a single straight line on the game board.

7. A game sheet used in a game system to be played by at least two players, the game sheet comprising:
a plurality of scattered dots;
a plurality of line segments connecting each of the plurality of dots to at least two other dots of the plurality of dots and arranged so as not to intersect each other; and
a plurality of marks placed one by one in any one of polygons formed by the plurality of line segments,
wherein the game sheet is configured to be used in a game where positioners assigned to each player are arranged at any of the plurality of dots, and each player obtains a territory defined by linearly connecting the positioners of the each player arranged at any of the plurality of dots among the plurality of positioners.

8. A game program executed by a game device designed for at least two players to play a game, the game device having a display unit, a control unit configured to control operations of the game device, and an input unit configured to transmit a signal corresponding to an action subjected to an object displayed on the display unit to the control unit, the game program comprising:
a display controlling step of displaying a game board object provided with a plurality of scattered dots and a plurality of marks arranged at positions spaced from the plurality of dots, positioning objects to be arranged at any of the plurality of dots and assigned to each of the players, and boundary indication objects linearly connecting the positioning objects arranged at any of the plurality of dots among the plurality of positioning objects assigned to each of the players to indicate a defined territory;
a turn order setting step of allowing one of the positioning objects assigned to each of the players to be in a movable state in a predetermined order;
an object moving step of, when a predetermined first action is made on one of the positioning objects in the movable state and a predetermined second action is made on one of the plurality of dots satisfying a predetermined condition, moving the positioning object on which the first action is made to the dot on which the second action is made; and
a boundary update step of updating the boundary indication objects based on a position of the positioning object moved at the object moving step.

9. The game program according to claim 8, wherein a plurality of line segments connecting each of the plurality of dots to at least two other dots of the plurality of dots and arranged so as not to intersect each other are arranged on the game board object.

10. The game program according to claim 9, wherein the plurality of marks are placed one by one in any one of polygons formed by the plurality of line segments.

11. The game program according to claim 8, further comprise a setup step of determining arrangements of the plurality of dots such that any one of the plurality of dots and any two dots adjacent to the one dot are not located on a single straight line.

12. (canceled)

13. The game system according to claim 1, wherein the game board comprises a steel board and each of the positioners comprises a magnet.

14. The game sheet according to claim 7, wherein the game sheet is attached on a steel board.
